(19) United States
(12) Patent Application Publication
(10) Pub. No.: US 2019/0072423 A1
(43) Pub. Date: Mar. 7, 2019

(54) Container Data Module for Dispensed Liquid

(71) Applicants: Bak Hang Stanley Poon, Kowloon (CN); Carlos A. Lopez, Key Biscayne, FL (US)

(72) Inventors: Bak Hang Stanley Poon, Kowloon (CN); Carlos A. Lopez, Key Biscayne, FL (US)

(21) Appl. No.: 16/016,845

(22) Filed: Jun. 25, 2018

Related U.S. Application Data
(60) Provisional application No. 62/613,887, filed on Jan. 5, 2018.

(51) Int. Cl. G01F 11/26

(52) U.S. Cl. CPC G01F 11/262

(57) ABSTRACT

A data module is adapted for mounting to a liquid container, such as a water bottle, a wine bottle etc., for automatically calculating or monitoring the amount of liquid dispensed from the container. The module employs a pair of metal rings which function as a sensor to activate a timer as liquid passes through an outlet opening. The data may be used to calculate the amount of dispensed liquid and may be either stored at the module and/or may be wirelessly communicated from the module.

### BACKGROUND

This disclosure relates generally to devices and methods for automatically determining the amount of liquid dispensed from a container. More particularly, this disclosure relates to devices and techniques for automatically generating the quantity of liquid dispensed from a bottle or the like.

Numerous devices and techniques have been advanced which automatically generate and compile data which is indicative of the quantity of liquid dispensed from a drink bottle or other similar container. Many other devices and techniques involve transmission of data to a remote device. Various techniques have been developed for generating the basic data and employing the data to calculate or measure the dispensed liquid. For some applications, the liquid intake of a user may be automatically monitored.

The present disclosure is directed to developing a module which can be easily mounted to a water bottle, a wine bottle or the like and configured to efficiently generate data as liquid is dispensed to thereby calculate the quantity of dispensed liquid. The module is also capable of storing the data and/or wirelessly communicating the data to a remote device or location. In some applications, the liquid intake by a user of a liquid, such as water, is automatically monitored.

### SUMMARY

Briefly stated, a liquid bottle and a module therefor comprises a bottle having an opening and a data module assembly. The data module assembly is mounted to the bottle and fluidly communicates with the opening. The module comprises a base that forms an axially extending channel defining a passageway leading to a second opening. A pair of axially spaced metal rings extends inwardly in the channel. A microprocessor is mounted to the base and conductively communicates with the rings. The microprocessor has a data storage and automatically records the time interval wherein liquid passes through the second opening and calculates the volume of the dispensed liquid and stores the data indicating the liquid volume in the data storage. The transmitter transmits data to a remote receiver. A display at the module displays data indicative of the liquid volume passing through the second opening.

The microprocessor and the transmitter are preferably integrated into a unitary component. The bottle, in one embodiment, is a plastic water bottle. In another embodiment, the bottle is a wine bottle. The base receives a battery for the microprocessor. The display may comprise an LCD at the module.

A liquid container and module comprises a data module assembly mounted to the container and fluidly communicates with the container. The base defines an axial extending channel. A sensor extends inwardly into the channel. The microprocessor is mounted to the base and conductively communicates with the sensor. The microprocessor has a data storage and determines a time interval wherein liquid passes from the container through the channel as sensed by said sensor. The microprocessor calculates the volume of the liquid and stores data indicative of the volume in the data storage. A transmitter transmits data to a remote receiver.

The microprocessor and transmitter are integrated into a unitary component. The sensor comprises a pair of axially spaced metal rings.

A liquid bottle and data module comprises a data assembly which is mounted to a bottle. The module assembly comprises a base defining an axially extending channel having an outlet. A pair of axially spaced metal sensor elements extends inwardly in the channel. A microprocessor is mounted to the base and communicates with the sensor elements. The microprocessor has a data storage. The microprocessor determines a time interval wherein liquid passes from the bottle through the outlet and employs the time to calculate the volume of the liquid. Data indicative of the dispensed volume is stored in the data storage. The microprocessor and transmitter are integrated into a unitary component and data is further wirelessly transmitted remotely from said module by the transmitter.

The bottle may be a plastic water bottle or a wine bottle. The module also has a base which receives a battery for the microprocessor. An LCD displays a quantity of dispensed liquid at the module. The module may further have a reset button. In one embodiment, the module has an offset structure orthogonal to the channel and defines a compartment for the microprocessor and a battery.

### BRIEF DESCRIPTION OF THE DRAWINGS

FIG. 1 is a perspective view of a liquid container and a data module for automatically producing dispensed liquid data;

FIG. 2 is a top plan view of the container and module of FIG. 1;

FIG. 3 is an exploded view of the container and module of FIG. 1;

FIG. 4 is a schematic diagram for the module of FIG. 1;

FIG. 5 is a schematic circuit diagram for the module of FIG. 1;

FIG. 6 is an annotated schematic view illustrating the operation and data processing of the module;

FIG. 7 is a block diagram illustrating remote data communication and display for the module of FIG. 1;

FIG. 8 is a perspective view of a wine bottle and a second embodiment of a module for automatically producing dispensed liquid data;

FIG. 9 is an exploded view of the module and a portion of the bottle of FIG. 8;

FIG. 10 is an enlarged sectional view, portions removed, of the module and bottle of FIG. 8;

FIG. 11 is a perspective view of the module of FIG. 8;

FIG. 12 is a second perspective view of the module of FIG. 8; and

FIG. 13 is a top view of another embodiment of the module of FIG. 1 and further illustrating various alternative features thereof.

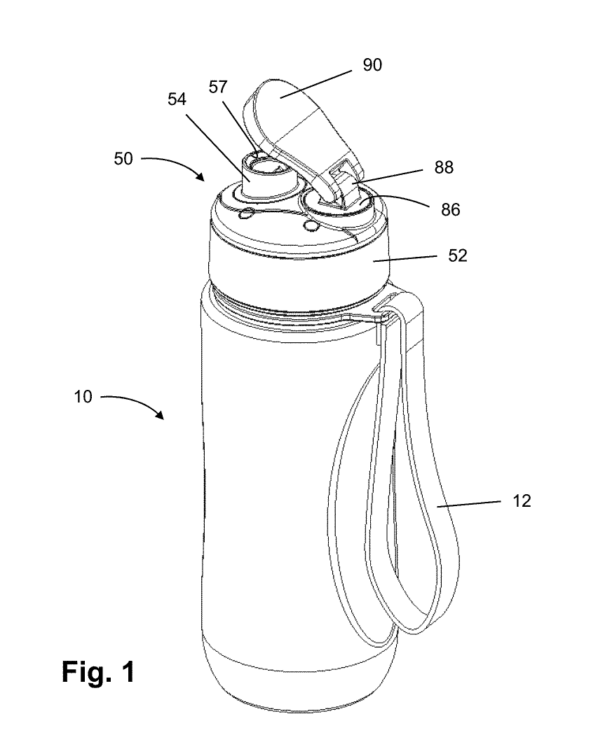

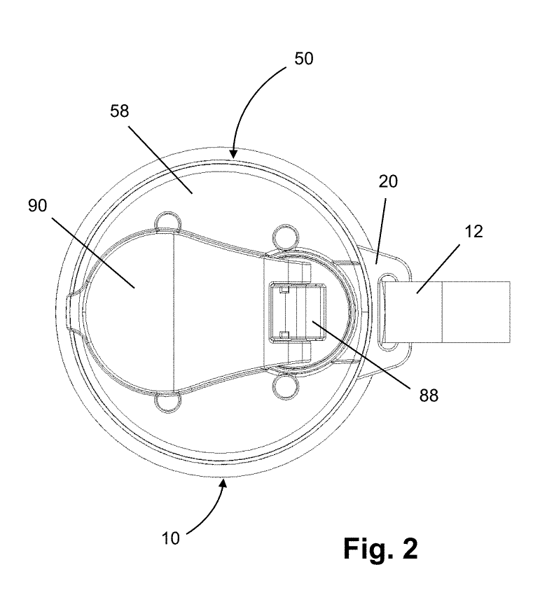

### DETAILED DESCRIPTION

With reference to the drawings, wherein like numerals represent like parts throughout the several figures, a liquid container in the form of a plastic drinking bottle is generally designated by the numeral 10 together with a module 50 which automatically generates data employable for determining the quantity of water dispensed from the container. The liquid container 10 has a generally conventional form and function and is intended to be representative of numerous possible container configurations. For descriptive purposes, container 10 is a water bottle. Container 10 includes a handle 12 and an upper threaded portion 14 which receives a cap-like platform 52 that mounts the components of the module 50.

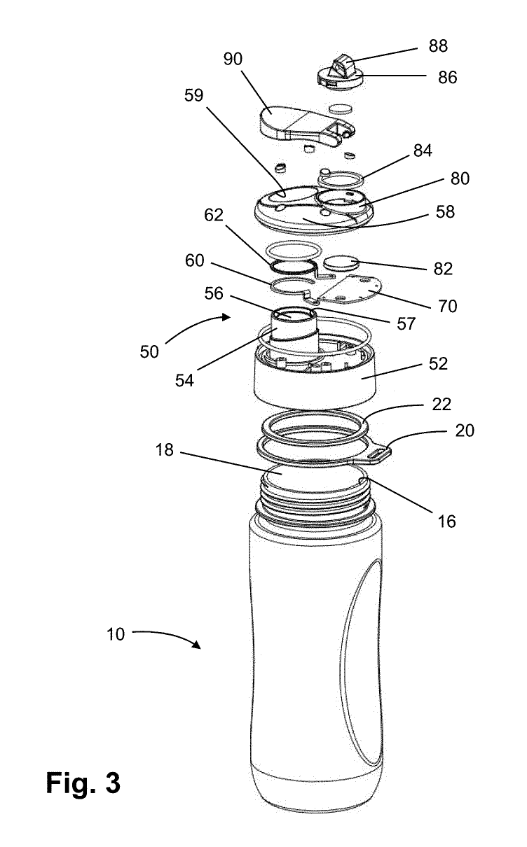

With reference to FIG. 3, the water bottle 10 includes an upper opening 18 which is formed by a threaded spout 16. A hanger 17 and a gasket 22 are captured by the platform 52. The platform 52 has a cylindrical periphery and interiorly threads to the container thread portion 14 and essentially functions as the base for the module 50.

The platform 52 integrally supports a projecting spout 54 which forms an axial passage 56 having an outlet 57. A pair of axially spaced, plate-like metal rings 60 and 62 surrounds the passage and are exposed to liquid traversing the passage. The metal rings electrically connect with a printed circuit board assembly 70 received or potted onto the cap. An upper cover 58 encloses the platform 55 and includes an opening 59 through which the spout extends.

An integral cylindrical compartment 80 projects from the cover 58. A battery 82 is received in the battery compartment and is sealed by a gasket 84 and a battery cover 86. The battery 82 is preferably a CR2023 battery.

The battery cover forms a yoke 88 for receiving a pair of pins for pivotally mounting the outlet lid 90 which seals the spout outlet 57. It will be appreciated that the foregoing module 50 and container 10 assembly allows for the outlet lid 90 to be pivoted open to allow water to be dispensed from the container through the spout 54 and outlet 57 which water path traverses through the exposed axially spaced metal rings 60 and 62.

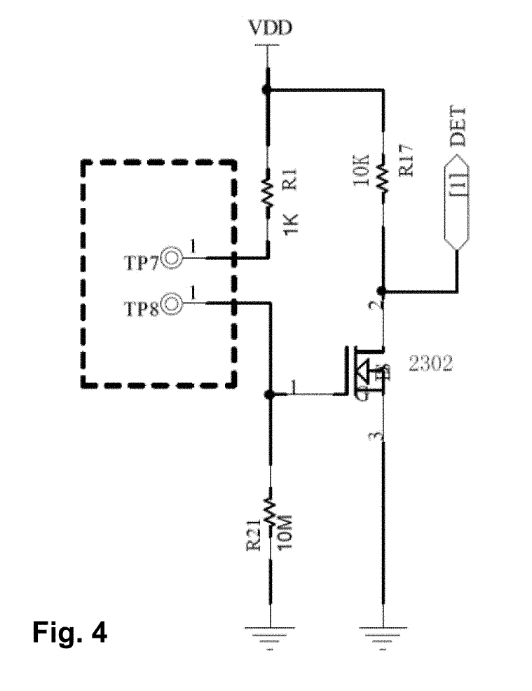

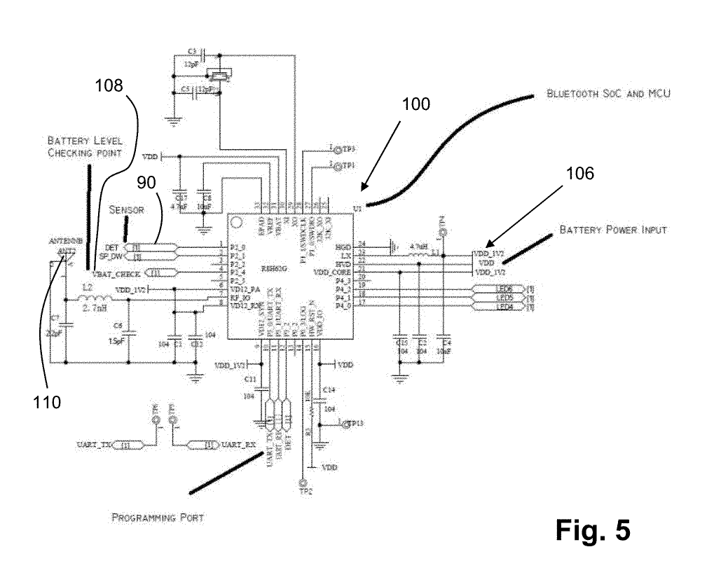

With reference to FIGS. 4 and 5, the metal rings 60 and 62 electrically connect at TP7 and TP8, respectively, to close a circuit when water flows through the spout 54 past the rings 60 and 62. The circuit closure is generated at DET1 which forms an input 90 to start the clock of a microprocessor 100. The timing steps are essentially measured in terms of 0.001 second intervals.

The microprocessor 100 is preferably a Realtek RTL8762AG-CG Bluetooth Low Energy SoC. The latter component supports a Bluetooth 4.2, an OTA over the ear programming mechanism firmware upgrade, a Bluetooth low energy PHY and an AES128/192/256 encrypt/decrypt engine. The microprocessor 100 has a programming port 104. The processor totals the time and stores the data for transmission via the antenna 110 and in some embodiments, communication to an LCD 120 (FIG. 13) mounted to the cover 58. The power input from battery 82 is applied at 106. The battery level checking point at 108 monitors the power supply of the battery 82.

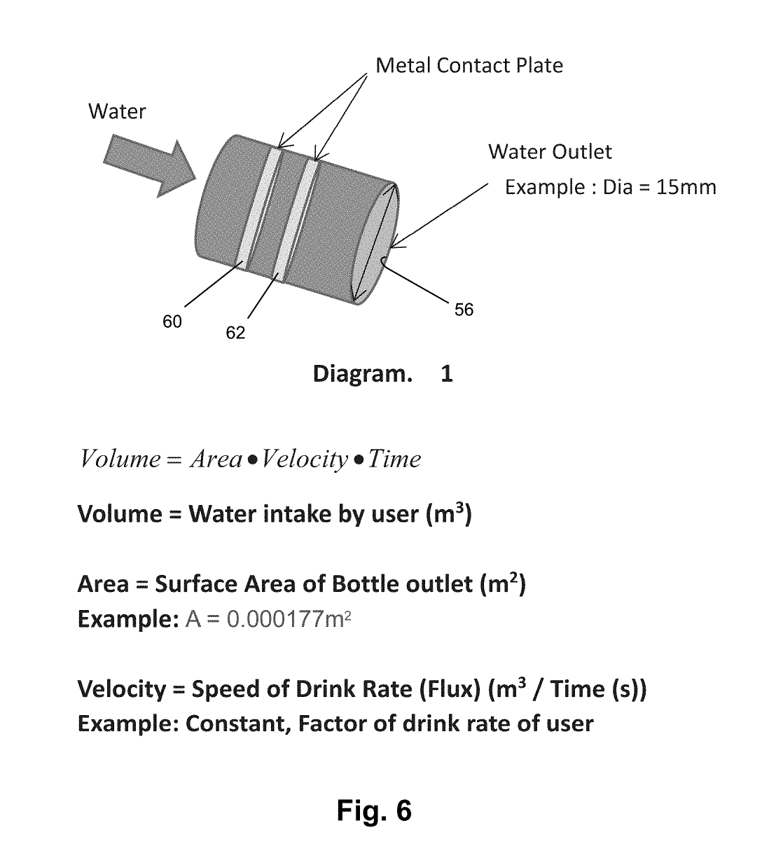

As best illustrated in FIG. 6, the volume dispensed from the container (or the water intake by the user) in cubic millimeters is equal to the area×the velocity×the time. The area is equal to the surface area of the bottle outlet 57 in m². The velocity is equal to the speed of the drink rate or the flux volume per time. The velocity can be either a constant which is calculated for a group or an individual user or can be empirically determined by the drink rate of the user. The microprocessor 100 has a storage which stores the total time interval for each drink. The accumulated dispensed or consumed liquid volume can be calculated and optionally displayed at LCD 120. In a preferred form, the data is transmitted for display of the dispensed or consumed liquid volume at a remote mobile electronic device 130 or computer 140. The consumed liquid volume can be employed in the context of a liquid monitoring protocol.

The electronic circuitry is preferably a combination of the microprocessor and a wireless front end. If the microprocessor does not contain the wireless system on chip (SoC), it will be appreciated that a wireless transceiver 102 which can be Bluetooth, WI-FI, ZigBee, etc., is employed.

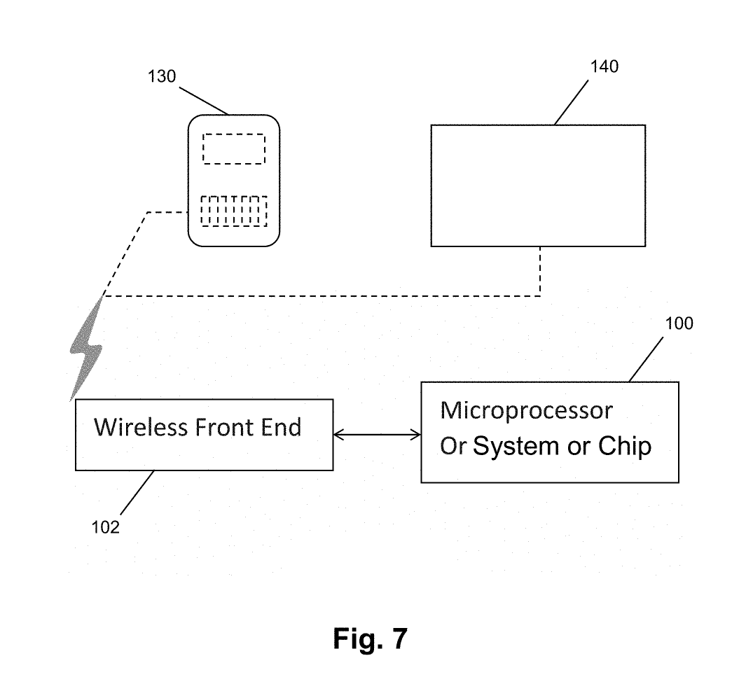

The microprocessor, in one embodiment, sends the total time interval for each drink (the data) to a mobile electronic device 130 or a computer 140 (See FIG. 7). The mobile device 130 may be an iOS™ or an Android™ device. Alternatively, or in addition, a direct display of the converted data in terms of liters, milliliters or cubic centimeters is visible on the LCD liquid display 120 installed on the bottle cover 58. It will be appreciated that the foregoing may be located at various alternative positions.

With reference to FIG. 13, the bottle cover 58 with the installed LCD 120 preferably contains additional features. A buzzer 122 for a drinking alarm signals a pre-established consumed liquid threshold is reached. A low battery alert 124 indicates a low battery. A reset button 126 is pushed to zero out the stored data. The module generates the dispensed liquid data from the drinking bottle and converts the time interval to the dispensed water volume by a very accurate and reliable estimation which can be further processed.

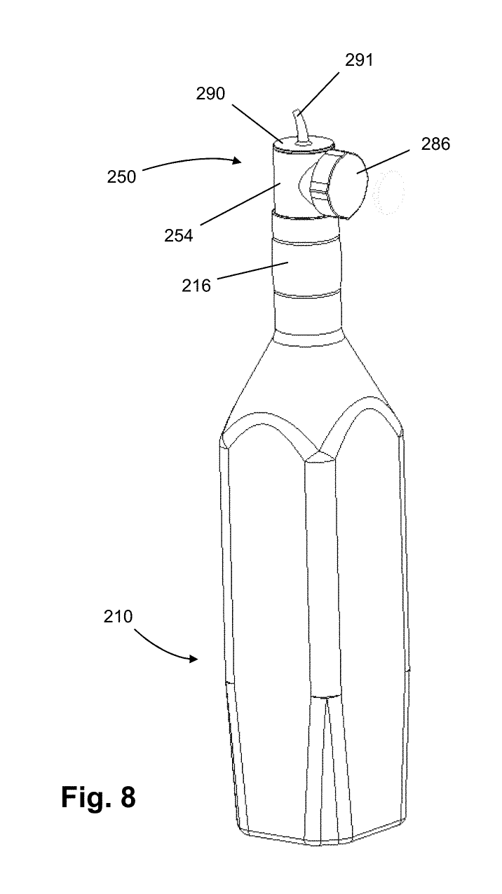

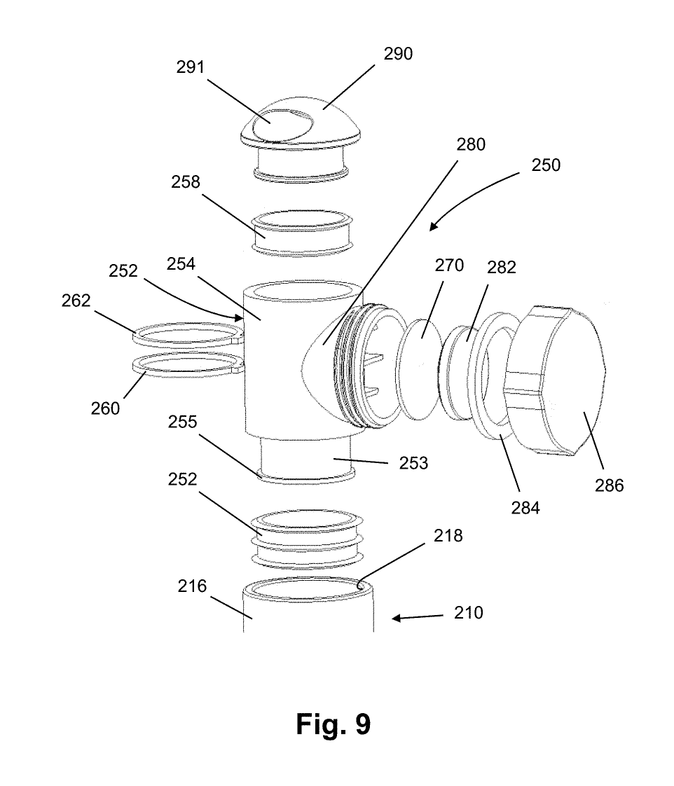

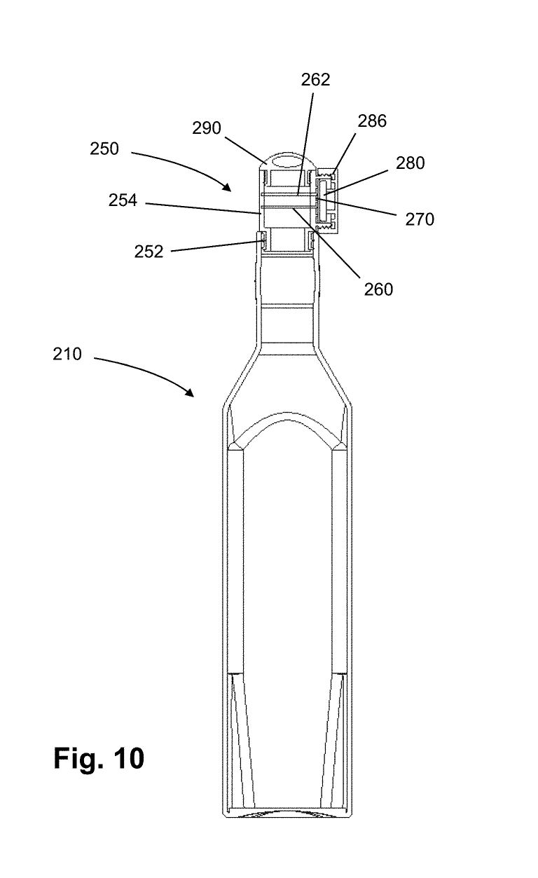

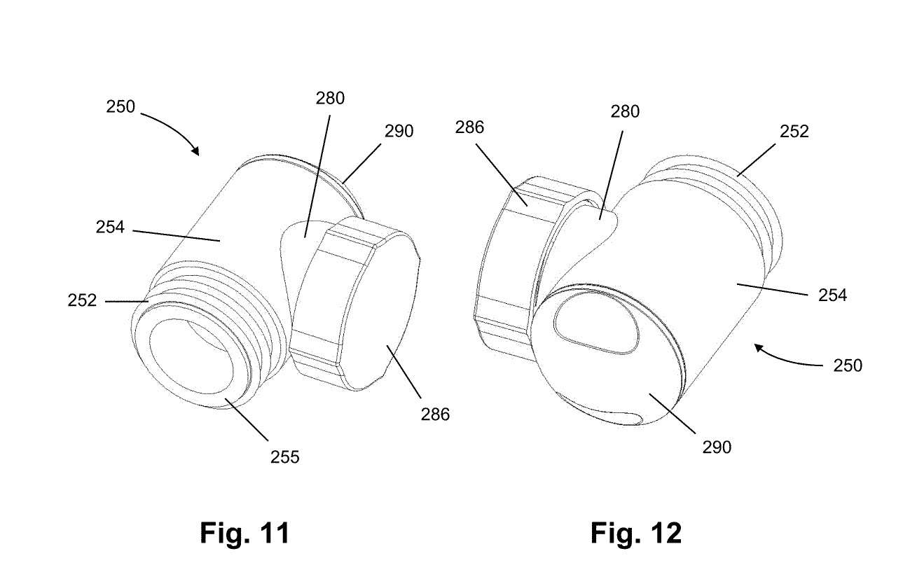

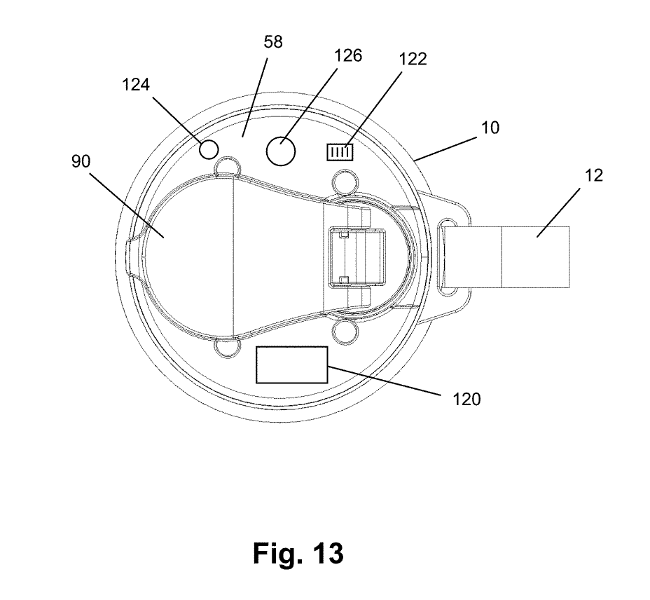

With reference to FIGS. 8-12, a second embodiment of a liquid container and a data module is employed for a wine bottle 210 that receives the data module 250. The wine bottle 210 includes an upper narrow spout 216 which has an opening 218. A gasket 212 receives an injection molded body 252 having a reduced lower cylindrical portion 253 with a lip 255 that engages with the gasket.

The module body 250 is a molded component having an intermediate axial cylindrical section 254 and orthogonal offset 280. The section 254 defines an axial passage 256 through the body. The passage leads to an opening 259 which is generally coaxial with the throat of the wine bottle. Axially spaced ring-like plates 260 and 262, which function as the electroplate sensors, are mounted at the interior of the body section 254. The rings 260 and 262 are exposed to liquid (wine) passing through the passage 256 to effectively close a circuit. A gasket 258 is interposed at the upper portion of the body section and slidingly receives a cover 290 which may have a restricted opening 291 or a tab 292.

The offset 280 forms a compartment which receives the printed circuit board 270 with the various chips and electrically communicates with the rings 260 and 262. A 2032-type battery 282 is also received in the compartment. A gasket 284 is mounted to seal with a knob-like battery door or closure 286 which is threadable to an exterior threading of the offset.

The printed circuit board and the antenna and other items may be substantially similar in form and function to that previously described for microprocessor 100 and antenna 110, and the electronics, processing, storing and communication may be accomplished in substantially the same manner as for module 50.

As wine is poured from the bottle through the opening, a circuit is completed between the rings 260 and 262 which start the microprocessor timer. The amount of dispensed liquid is then calculated in substantially the same fashion as that previously described for the liquid bottle 10 and data module 50.

The data indicative of the wine dispensed from the bottle may be stored in the microprocessor memory or may be transmitted to a remote location such as a remote server or other device in which the dispensed wine data can be compiled and calculated. Bottle 210 alternatively may be a liquor bottle or a bottle for other liquids.

With reference to FIG. 13, a cover for either a drink bottle or a wine bottle may be affixed with an LCD 120 which displays the amount of consumed or dispensed liquid. In addition, a dispensing limit indicator 122, a reset button 126 and a low battery indicator 124 may also be affixed at the cover 290 (not illustrated in FIG. 13) or otherwise located on the module 250.

While preferred embodiments of the foregoing have been set forth for purposes of illustration, the foregoing description should not be deemed a limitation of the invention herein. Accordingly, various modifications, adaptations and alternatives may occur to one skilled in the art without departing from the spirit and the scope of the present invention.

1. A liquid bottle and module therefor comprising:
a bottle defining an opening;
a data module assembly mounted to said bottle and communicating with said opening comprising:
a base with an axially extending channel defining a passageway leading to a second opening;
a pair of axially spaced metal rings extending inwardly in said channel;
a microprocessor mounted to said base conductively communicating with said rings and having a data storage and automatically recording a time interval wherein liquid passes from said bottle through said second opening and calculating the volume of said liquid as a function of said time interval and storing said data indicative thereof in said data storage; and
a transmitter which wirelessly transmits data to a remote receiver.

2. The bottle and data module of claim 1 wherein the microprocessor and transmitter are integrated into a unitary component.

3. The bottle and data module of claim 1 wherein the bottle is a plastic water bottle.

4. The bottle and data module of claim 1 wherein the bottle is a wine bottle.

5. The bottle and data module of claim 1 wherein said base receives a battery for said microprocessor.

6. The bottle and data module of claim 1 and further comprising a display which displays data indicative of the liquid volume passing through said opening.

7. A liquid container and module therefor comprising:
a liquid container defining an opening;
a data module assembly mounted to said container and fluidly communicating with said opening comprising:
a base defining an axially extending channel;
a sensor located adjacent said channel and exposed to liquid passing through said channel;
a microprocessor mounted to said base conductively communicating with said sensor and having a data storage and determining a time interval wherein liquid passes from said container through said channel as sensed by said sensor, and calculating the volume of said liquid, and storing data indication thereof in said data storage; and
a transmitter which transmits said data to a remote receiver.

8. The container and data module of claim 7 wherein the microprocessor and transmitter are integrated into a unitary component.

9. The container and data module of claim 7 wherein the container is a plastic water bottle.

10. The container and data module of claim 7 wherein the container is a wine bottle.

11. The container and data module of claim 7 wherein said base receives a battery for said microprocessor.

12. The container and data module of claim 7 and further comprising a display which displays data indicative of volume of liquid passing from said container.

13. The container and data module of claim 7 wherein said sensor comprises a pair of axially spaced metal rings.

14. A liquid bottle and module therefor comprising:
a bottle defining an opening;
a data module assembly mounted to said bottle comprising:
a base defining an axially extending channel communicating with said opening and having an outlet;
a pair of axially spaced metal sensors located for exposure to liquid in said channel;
a microprocessor mounted to said base communicating with said sensors and having a data storage and determining a time interval wherein liquid is dispensed from said bottle through said outlet and calculating the volume of said dispensed liquid and storing data indicative thereof in said data storage; and
a remote display which displays data indicative of the liquid volume dispensed through said outlet.

15. The bottle and data module of claim 14 wherein the microprocessor and a transmitter are integrated into a unitary component and data is transmitted by said transmitter to a remote location.

16. The bottle and data module of claim 1 wherein the bottle is a plastic water bottle or a wine bottle.

17. The bottle and data module of claim 14 wherein said base receives a battery for said microprocessor.

18. The bottle and data module of claim 14 wherein said remote display is located on a mobile electronic device.

19. The bottle and data module of claim 14 further comprising a reset button.

20. The bottle and data module of claim 17 further comprising an offset structure orthogonal to said channel and defining a compartment for said microprocessor and said battery.
